(19) United States
(12) Patent Application Publication
(10) Pub. No.: US 2021/0378262 A1
(43) Pub. Date: Dec. 9, 2021

(54) HARDENED ANTLER PRODUCT AND METHOD OF MANUFACTURE

(71) Applicant: Antler Chewz, Inc., Winnipeg (CA)

(72) Inventor: Victor Lazepko, Winnipeg (CA)

(21) Appl. No.: 17/287,048

(22) PCT Filed: Nov. 26, 2019
(86) PCT No.: PCT/US19/63467

§ 371 Date: Apr. 20, 2021

Related U.S. Application Data
(60) Provisional application No. 62/773,638, filed on Nov. 30, 2018.

(51) Int. Cl. A23K 10/26; A23K 40/25; A23K 40/20; A23K 50/42; A23K 20/147; A23K 20/158; A23K 10/30; A01K 15/02

(52) U.S. Cl. CPC A23K 10/26; A23K 40/25; A23K 40/20; A01K 15/026; A23K 20/147; A23K 20/158; A23K 10/30; A23K 50/42

(57) ABSTRACT

A hardened antler product and corresponding methods of manufacture are disclosed. The hardened antler product may include a ground antler composition comprising antler powder. The antler powder may comprise ground calcified antler. The ground antler composition may furthermore comprise one or more additional ingredients disclosed herein. The ground antler composition is mixed with a wetting ingredient and pressed to produce hardened antler products, or formed into antler powder resin pellets which can be injection molded to produce hardened antler products, as described herein.

### CROSS REFERENCE TO RELATED APPLICATION

This application is a U.S. National Stage filing under 35 U.S.C. § 371 of International Application No. PCT/US19/63467, filed on Nov. 26, 2019, which claims priority to U.S. Provisional Patent Application No. 62/773,638, filed Nov. 30, 2018 and entitled “HARDENED ANTLER PRODUCT AND METHOD OF MANUFACTURE.” The prior applications are incorporated by reference in their entirety.

### BACKGROUND

Antlers, such as deer and elk antlers, have been used extensively for decoration as well as for human and pet nutritional purposes. Nutritional uses include antler powders, sprays, and extracts, as well as antler pet chews, for example as described in Shrestha, “Antler Pet Chews and Methods of Manufacture,” U.S. Pat. Pub. No. 2016/316,787. Antler is considered to have significant health benefits.

Often, antler nutritional products are made from “antler velvet.” Antler velvet is tissue that covers the bone and cartilage of the antler. The bone and cartilage eventually develop into mature, calcified antlers. In contrast, “calcified antler” is the mature antler remaining at the end of the antler growth stage, after the antler velvet has substantially receded. The term “antler” will be used herein to refer generally to antler velvet as well as calcified antler, and the more specific terminology will be used as necessary to refer to specific types of antler.

There are a variety of challenges facing the antler products industry. For example, one challenge is the humane and sustainable sourcing of antler in sufficient quantity to meet demand. To meet this and other challenges, the industry is in need of new antler-based products and processing methods.

### SUMMARY

This disclosure presents hardened antler products and corresponding methods of manufacture. Example hardened antler products may include a ground antler composition, the ground antler composition comprising antler powder as a significant component thereof. The antler powder may comprise ground calcified antler. In some embodiments, the antler powder may comprise no antler velvet, or substantially no antler velvet. The ground antler composition may furthermore comprise one or more additional ingredients such as those disclosed herein. The ground antler composition can be mixed with wetting and bonding agents and pressed to produce hardened antler products described herein. While a wide variety of product types are possible, some examples may include pet chews for nutrition and diversion of dogs or other pets.

Example methods to manufacture a hardened antler product may include making a ground antler composition by grinding calcified antler in order to produce an antler powder, and mixing the antler powder with one or more additional ingredients disclosed herein, so that the antler powder is a significant component of the ground antler composition. The ground antler composition may next be mixed with a wetting/bonding/texturing agent comprising, e.g., vegetable glycerin, gelatin as a bonding agent, water as a wetting agent, and/or sunflower oil optionally mixed with sunflower seed lecithin as a texturing agent. The combined mixture may be extruded, pressed, and/or molded into a desired form, and dried to produce the final hardened antler product. Further aspects of the invention are described in detail below.

### BRIEF DESCRIPTION OF THE DRAWINGS

Various features and attendant advantages of the disclosed technologies will become fully appreciated when considered in conjunction with the accompanying drawings, in which like reference characters designate the same or similar parts throughout the several views, and wherein:

FIG. 1 provides a first example method of manufacturing a hardened antler product.

FIG. 2 provides a second example method of manufacturing a hardened antler product.

FIG. 3 is a perspective view of an example hardened antler product.

FIG. 4 is another perspective view of the example hardened antler product introduced in FIG. 3.

FIG. 5 is a front plan view of the example hardened antler product introduced in

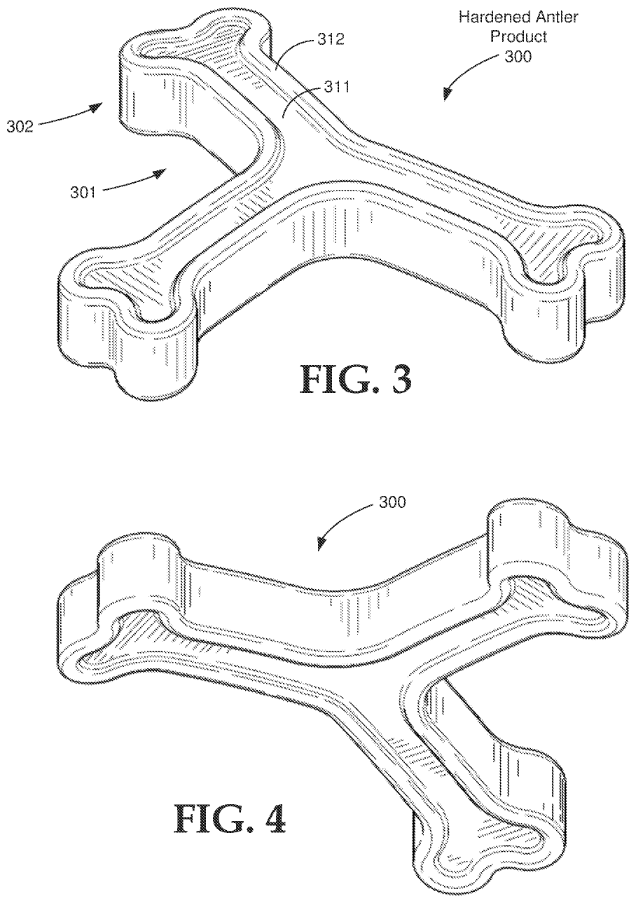

FIG. 3.

FIG. 6 is a back plan view of the example hardened antler product introduced in

FIG. 3.

FIG. 7 is a top elevation view of the example hardened antler product introduced in FIG. 3.

FIG. 8 is a bottom elevation view of the example hardened antler product introduced in FIG. 3.

FIG. 9 is a right side elevation view of the example hardened antler product introduced in FIG. 3.

FIG. 10 is a left side elevation view of the example hardened antler product introduced in FIG. 3.

### DETAILED DESCRIPTION

Prior to explaining embodiments of the invention in detail, it is to be understood that this disclosure is not limited to the details of construction or arrangements of the components and method steps set forth in the following description or illustrated in the drawings. Embodiments of this disclosure are capable of other embodiments and of being practiced and carried out in various ways. Also, it is to be understood that the phraseology and terminology employed herein are for the purpose of the description and should not be regarded as limiting.

This disclosure presents hardened antler products and corresponding methods of manufacture. One example hardened antler product can be a dog chew, however the structures and techniques described herein may serve a wide variety of other applications including edible products, decorative products, functional products, and other products as will be appreciated. In general, the hardened antler products disclosed herein can be made from a composition comprising antler powder, and the antler powder may comprise ground calcified antler. The use of such an antler powder improves available antler supply by providing a use for antler which may not otherwise be commercially viable. The antler powder may be mixed with any number of other ingredients, as well as wetting/bonding/texturing agents as described herein, and molded into hardened antler products of any desired size or shape.

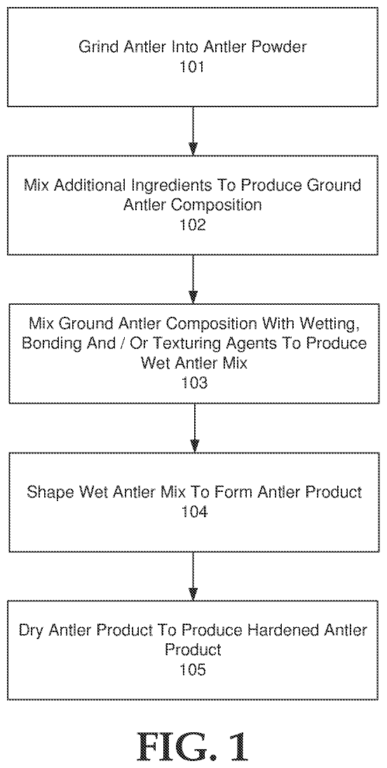

FIG. 1 provides a first example method of manufacturing a hardened antler product in accordance with some embodiments of this disclosure. At the “Grind Antler into Antler Powder” block 101, deer, elk, or other antler or antler fragments may be ground into a powder. In some embodiments, the antler may comprise primarily calcified antler. The term “calcified antler” may include antler that is, e.g., at least 90% calcified. In some embodiments, the antler may include no antler velvet, or substantially no antler velvet. In other embodiments, antler velvet may be included to any desired degree—the inclusion of antler velvet or substitution of antler velvet for calcified antler does not render the disclosed processes infeasible. The grinding may be done by hand or by machine, or both. The antler powder may be any desired coarseness, from very fine to coarse in consistency.

At the “Mix Additional Ingredients To Produce Ground Antler Composition” block 102, any of a variety of additional ingredients may be mixed with the antler powder resulting from block 101. In some embodiments, the resulting ground antler composition may comprise at least 50% antler powder from block 101, and up to 50% additional ingredients. In some embodiments, the resulting ground antler composition may comprise over 50% antler powder from block 101, and under 50% additional ingredients. In some embodiments, the resulting ground antler composition may comprise antler powder as a significant ingredient, e.g., the ground antler composition may comprise 5% or more antler powder. In some embodiments, the resulting ground antler composition may comprise at least 10% antler powder. In some embodiments, the resulting ground antler composition may comprise antler powder as a main ingredient, e.g., the ground antler composition may include comparatively as much or more antler powder as any other single ingredient. In some embodiments, the resulting ground antler composition may comprise antler powder as the main ingredient, e.g., the ground antler composition may include comparatively more antler powder than any other single ingredient.

Various example additional ingredients, and example proportions thereof, are disclosed below, with the understanding that those of skill may substitute other ingredients and/or modify the proportions.

Example dry ingredients include rice flour, brown rice flour, potato flour, oat flour, pea starch, gelatin 100P, colloid 100, colloid 7850, spray dried egg, oat fiber, sodium caseinate, palatant AFB 403-AQ, sunflower lecithin, sodium tripolyphosphate, zinc propionate, dry OxyGon, blueberry powder, cranberry powder, and pumpkin powder. Example liquid ingredients include glycerin, water, sunflower oil, chicken fat, and coconut oil. Example proportions of the various ingredients are set forth in the below chart. Any of the below example ingredient proportions may be used in some embodiments, whether or not the various other ingredients are used in the below example proportional amounts.

Glycerin, Vegetable ADM 15-17%
Water 12-14%
Antler Powder 8.5-9%
Tapioca Starch 5.5-6%
Colloid 100 (Gelatin 100P) 5.5%
Potato Flour 6-7%
Pea Starch 7-8%
Sodium Caseinate 2%
Sunflower Seed Lecithin, Dry 1.5%
Sunflower Seed Oil 0.5-1%
Oat Fiber, 770 3%
Digest, AFB DD-403AQ 2%
Previon 0.2-0.5%
NaturOx Plus Dry 0.2%
Blueberry Powder 0.16%
Cranberry Fiber 0.16%
Pumpkin, Powder 0.16%

In some embodiments, blocks 102 and 103 may be combined into a single block. In other embodiments, block 103 may be performed separately and optionally subsequent to block 102. At the “Mix Ground Antler Composition with Wetting, Bonding and/or Texturing Agents to Produce Wet Antler Mix” block 103, one or more wetting, bonding and/or texturing agents ingredients may be added to the ground antler composition produced at block 102 in order to produce a wet antler mix. For example, gelatin 100P (colloid 100) may be added at block 103 as a bonding agent. Sunflower oil and/or sunflower lecithin may be added at block 103 as a texturing agent, which may additionally produce a “sandpaper” effect on the extruder, press, mold or other device used at block 104. Water and/or other liquid ingredients may be added as wetting agents.

At the “Shape Wet Antler Mix to Form Antler Product” block 104, the wet antler mix produced at block 103 may be placed in a forming device such as an extruder, press, or mold in order to produce an antler product of desired shape, size, and density. In some embodiments, antler products may be injection molded or hydraulically pressed in a mold. In some embodiments, antler products may be formed using an extruder machine, e.g., a single screw extruder machine. Example pet chew products may be made with a shape and size such as illustrated in FIGS. 3-10. Of course, numerous other shapes and configurations may be produced.

At the “Dry Antler Product To Produce Hardened Antler Product” block 105, the antler product may be removed from the forming device employed at block 104 and allowed to dry, e.g., at room temperature, for a period of time. The result of block 105 may be the final hardened antler product, e.g., the product illustrated in FIGS. 3-10.

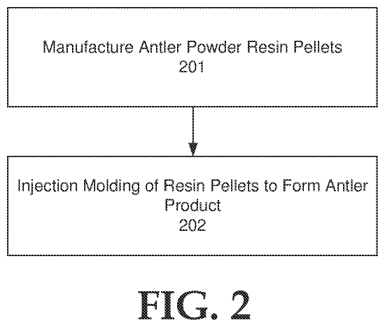

FIG. 2 provides a second example method of manufacturing a hardened antler product in accordance with some embodiments of this disclosure. FIG. 2 provides an example injection molding based approach to manufacturing the hardened antler product. At the “Manufacture Antler Powder Resin Pellets” block 201, operations such as described with reference to FIG. 1 may be performed to make an antler powder resin pellets. For example, operations at block 201 can include grinding calcified antler in order to produce an antler powder, mixing the antler powder with one or more additional ingredients to make a ground antler composition, in proportions such as described with reference to FIG. 1, e.g., such that the antler powder comprises at least a significant ingredient (five percent or more) of the ground antler composition, mixing the wetting, bonding, and/or texturing agents into the ground antler composition, and forming the resulting ground antler composition into the antler powder resin pellets.

At the “Injection Molding of Resin Pellets to Form Antler Product” block 202, the antler powder resin pellets manufactured at block 201 can be loaded as an input into an injection molding device and, the injection molding device can be used to injection mold the antler powder resin pellets to form an antler product such as illustrated in FIGS. 3-10.

In some embodiments, ingredients that may be suitable to make antler powder resin pellets can comprise, e.g., the ingredients described above with reference to FIG. 1. In various further embodiments, ingredients to make antler powder resin pellets can comprise, e.g., tapioca starch, chicken, glycerin, antler powder, brown rice flour, barley flour, sweet potato, gelatin, ground oats, molasses, natural flavor, sunflower lecithin, sunflower oil, blueberry powder, citric acid, mixed tocopherols, and/or rosemary extract.

Various example ingredients, and example proportions thereof, are disclosed below, with the understanding that those of skill may substitute other ingredients and/or modify the proportions. Furthermore, any of the below example ingredient proportions may be used in some embodiments, whether or not the various other ingredients are used in the below example proportional amounts.

| Approx. | Ingredients | |
|---|---|---|
| % of Total | Dry | Dry Mix % |
| 8.00% | Antler Powder | 10.46% |
| 6.00% | Gelatin | 7.843% |
| 26.60% | Tapioca Starch | 34.771% |
| 8.00% | Brown Rice Flour | 10.458% |
| 3.00% | Chicken | 3.922% |
| 8.00% | Barley Flour | 10.46% |
| 6.00% | Sweet Potato | 7.84% |
| 3.00% | Dry Molasses | 3.92% |
| 2.00% | Sunflower Lecithin | 2.61% |
| 3.00% | Whole Ground Oat Groats | 3.92% |
| 2.00% | AFB Pal B21029 | 2.61% |
| 0.30% | Previon (Citric Acid & Vinegar) | 0.39% |
| 0.10% | OxyGon, Dry (NatureOx) | 0.13% |
| 0.50% | Blueberry Powder | 0.65% |
| | Slurry | |
| 12.00% | Glycerin - Vegetable | |
| .50% | Sunflower Oil | |
| 10.00% | Est. Process water as needed | |

In embodiments using the above ingredients and proportions to make antler powder resin pellets, the total dry mix as a percent of the formula can comprise anything from 70-80%, e.g., 76.50%. The total slurry as a percent of the formula can comprise anything from 8-16%, e.g., 12%. The total slurry as a percent of dry mix can comprise anything from 10-20%, e.g., 15.69%.

FIG. 3 provides an example hardened antler product 300, in accordance with some embodiments of this disclosure. The manufacturing processes described herein may result in any number of different products. The illustrated example product 300 is a pet chew which can be made in various example sizes. A large product 300 can weigh, e.g., about 40-50 grams, can be about 10-15 mm thick, and can measure about 100-120 mm between arm ends. A medium product 300 can weigh, e.g., about 20-30 grams, can be about 8-12 mm thick, and can measure about 80-90 mm between arm ends. A small product 300 can weigh, e.g., about 10-20 grams, can be about 7-12 mm thick, and can measure about 60-80 mm between arm ends.

FIG. 3 provides just one example product, and a wide variety of other shapes, sizes and uses are possible as will be appreciated. For example, an example bone shaped pet chew can be, e.g., about three inches long and weigh about 25-39 grams, e.g., 32 grams, for medium size dogs. Smaller or larger sizes and different shapes may also be made as will be appreciated, for example, a hardened antler product which is about double the length (six inches) and double the weight (50-80 grams) may be suitable for larger dogs.

The illustrated hardened antler product 300 can be made from ground antler compositions such as described herein, for example, a composition comprising antler powder, the antler powder comprising ground calcified antler. The composition may include one or more additional ingredients, in proportions such as those described herein. The additional ingredients may include, inter alia, a wetting agent, a bonding agent, and/or a texturing agent such as those described herein. The ground antler composition may be shaped in a forming device and dried to produce the hardened antler product 300.

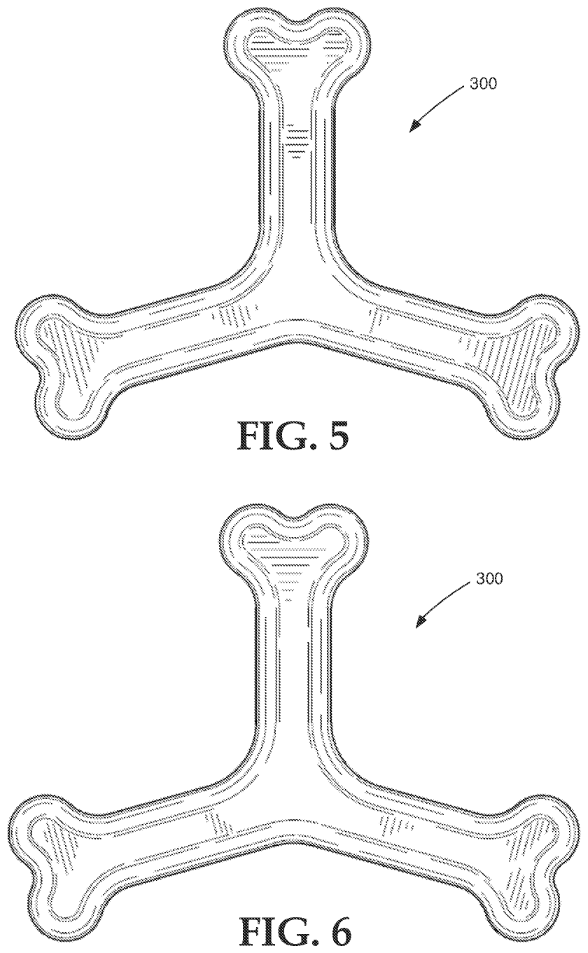

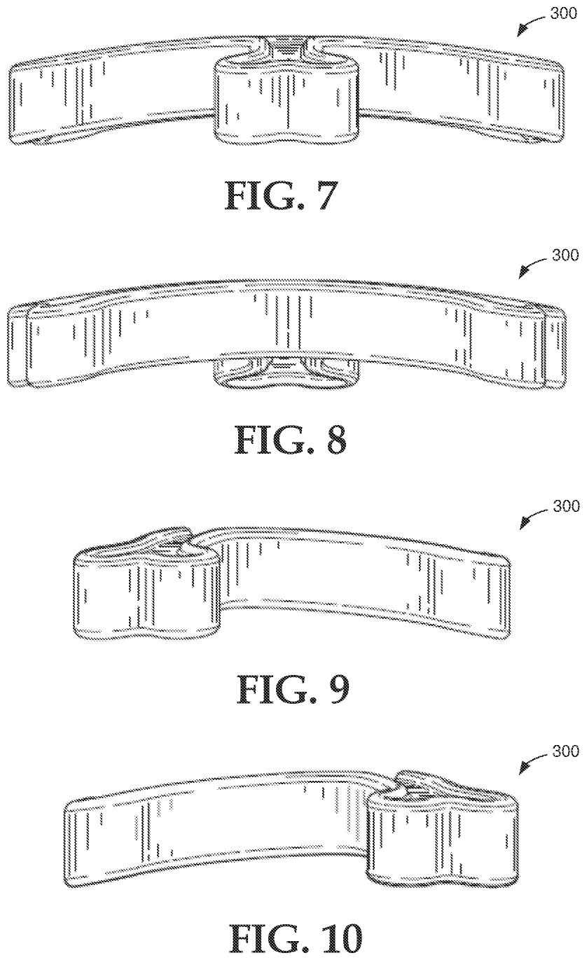

FIG. 3 is a perspective view of the example hardened antler product 300; FIG. 4 is another perspective view of the example hardened antler product 300; FIG. 5 is a front plan view of the example hardened antler product 300; FIG. 6 is a back plan view of the example hardened antler product 300; FIG. 7 is a top elevation view of the example hardened antler product 300; FIG. 8 is a bottom elevation view of the example hardened antler product 300; FIG. 9 is a right side elevation view of the example hardened antler product 300; and FIG. 10 is a left side elevation view of the example hardened antler product 300.

The hardened antler product 300 illustrated in FIGS. 3-10 comprises three arms 301, each arm 301 comprising an arm length which extends from a middle portion of the product 300, and each arm 301 comprising a bulbous end section 302 opposite the middle portion of the product 300. In the illustrated embodiment, a continuous raised rim 312 extends around an outer edge of the front of the product 300. Another, similar continuous raised rim extends around an outer edge of the back of the product 300. The rim 312 surrounds a substantially flat top surface 311 of the product 300, and the bottom rim similarly surrounds a substantially flat bottom surface of the product 300. Furthermore, the product 300 may have a curvature, wherein the front and back surfaces of the product are curved in parallel, such as illustrated in FIGS. 7-10. Other properties of the product 300 will be appreciated from FIGS. 3-10.

While various embodiments have been disclosed herein, other aspects and embodiments will be apparent to those skilled in art.

What is claimed is:

1. A hardened antler product made from a ground antler composition, comprising:
a ground antler composition, comprising:
antler powder, the antler powder comprising ground calcified antler, and wherein the antler powder is the main ingredient of the ground antler composition; and
one or more additional ingredients mixed with said antler powder, the additional ingredients including at least a wetting agent and a bonding agent;
wherein the ground antler composition is shaped to a desired form dried to produce the hardened antler product.

2. The hardened antler product of claim 1, wherein the wetting agent comprises one or more of Glycerin, Water, Chicken Fat, or Coconut Oil.

3. The hardened antler product of claim 1, wherein the bonding agent comprises gelatin.

4. The hardened antler product of claim 1, wherein the one or more additional ingredients comprise one or more of rice flour, brown rice flour, potato flour, oat flour, pea starch, gelatin 100P, colloid 100, colloid 7850, spray dried egg, oat fiber, sodium caseinate, palatant AFB 403-AQ, sunflower lecithin, sodium tripolyphosphate, zinc propionate, dry OxyGon, blueberry powder, cranberry powder, and pumpkin powder.

5. The hardened antler product of claim 1, wherein the ground antler composition further comprises a texturing agent.

6. The hardened antler product of claim 5, wherein the texturing agent comprises one or more of sunflower oil or sunflower lecithin.

7. The hardened antler product of claim 1, wherein the hardened antler product is a pet chew.

8. The hardened antler product of claim 6, wherein the pet chew weighs 25-39 grams.

9. A method to manufacture a hardened antler product, comprising:
making a ground antler composition, comprising:
grinding calcified antler in order to produce an antler powder;
mixing the antler powder with one or more additional ingredients, the additional ingredients including at least a wetting agent and a bonding agent, in proportions such that the antler powder is the main ingredient of the ground antler composition;
pressing the ground antler composition in a forming device; and
drying the pressed ground antler composition.

10. The method of claim 9, wherein the wetting agent comprises one or more of Glycerin, Water, Chicken Fat, or Coconut Oil.

11. The method of claim 9, wherein the bonding agent comprises gelatin.

12. The method of claim 9, wherein the one or more additional ingredients comprise one or more of rice flour, brown rice flour, potato flour, oat flour, pea starch, gelatin 100P, colloid 100, colloid 7850, spray dried egg, oat fiber, sodium caseinate, palatant AFB 403-AQ, sunflower lecithin, sodium tripolyphosphate, zinc propionate, dry OxyGon, blueberry powder, cranberry powder, and pumpkin powder.

13. The method of claim 9, wherein the ground antler composition further comprises a texturing agent.

14. The method of claim 13, wherein the texturing agent comprises one or more of sunflower oil or sunflower lecithin.

15. The method of claim 9, wherein the hardened antler product is a pet chew.

16. The method of claim 15, wherein the pet chew weighs 25-39 grams.

17. The method of claim 15, wherein the forming device comprises a single screw extruder machine.

18. The method of claim 15, wherein the forming device comprises a hydraulic press or an injection molding device.

19. A method to manufacture a hardened antler product, comprising:
manufacturing antler powder resin pellets, comprising:
grinding calcified antler in order to produce an antler powder;
mixing the antler powder with one or more additional ingredients to make a ground antler composition, in proportions such that the antler powder comprises five percent or more of the ground antler composition;
forming the ground antler composition into the antler powder resin pellets;
loading the antler powder resin pellets in an injection molding device; and
injection molding the hardened antler product.

20. The method of claim 19, wherein the one or more additional ingredients include at least gelatin, tapioca starch, brown rice flour, barley flour, and sweet potato.
